(19) United States
(12) Patent Application Publication
(10) Pub. No.: US 2026/0141230 A1
(43) Pub. Date: May 21, 2026

(54) METHODS AND SYSTEMS FOR GENERATING TASK-SPECIFIC OUTPUT USING A SINGLE QUANTIZED MODEL GRAPH

(71) Applicant: SAMSUNG ELECTRONICS CO., LTD., Suwon-si (KR)

(72) Inventors: Srinivas Soumitri MIRIYALA, Visakhapatnam (IN); Aakansha MISHRA, Mathura (IN); Prasanna R, Thanjavur (IN); Payal ANAND, Bangalore (IN); Manohara Krishnamurthy HOSAKOPPA, Chikkamagaluru (IN); Praveen Doreswamy NAIDU, Bangalore (IN); Venkappa MALA, Kurnool (IN)

(73) Assignee: SAMSUNG ELECTRONICS CO., LTD., Suwon-si (KR)

(21) Appl. No.: 19/446,448

(22) Filed: Jan. 12, 2026

Related U.S. Application Data
(63) Continuation of application No. PCT/KR2025/016288, filed on Oct. 15, 2025.

(30) Foreign Application Priority Data
Oct. 16, 2024 (IN) 202441054180
Sep. 25, 2025 (IN) 202441054180

(51) Int. Cl. G06N 3/0495; G06N 5/022

(52) U.S. Cl. CPC G06N 3/0495; G06N 5/022

(57) ABSTRACT

Methods, systems, and devices for generating a task-specific output using a single quantized model graph for a plurality of parameter efficient fine tuning (PEFT) models using generative artificial intelligence (AI), including: obtaining a base model; performing a quantization sensitivity analysis across the plurality of PEFT models to obtain a quantization sensitivity score (QSS) corresponding to each PEFT model; selecting a quantization-sensitive PEFT model based on a corresponding QSS; determining a fixed quantization configuration based on the selected quantization-sensitive PEFT model; adjusting one or more weights associated with the plurality of PEFT models based on the fixed quantization configuration; generating a single quantized model graph including the base model and the fixed quantization configuration; and performing inference by selecting any one of the adjusted model of PEFT models and generating the task-specific output using the single quantized inference graph.

### CROSS-REFERENCE TO RELATED APPLICATIONS

This application is a continuation of International Application No. PCT/KR2025/016288, filed on Oct. 15, 2025, in the Korean Intellectual Property Receiving Office, which is based on and claims priority to Indian Provisional Patent Application No. 202441054180, filed on Oct. 16, 2024, and Indian Patent Application number 202441054180, filed on Sep. 25, 2025, in the Indian Patent Office, the disclosures of which are incorporated by reference herein in their entireties.

### BACKGROUND

### 1. Field

The present disclosure relates to model optimization techniques, and more particularly to systems and methods for generating task-specific output using a single quantized model graph for a plurality of parameter efficient fine tuning (PEFT) models in a generative artificial intelligence (AI) system.

### 2. Description of Related Art

Generative artificial intelligence (AI) models, such as large language models (LLMs) and large vision models (LVMs), have demonstrated significant capabilities across a variety of applications, including chat, summarization, captioning, segmentation, and multi-agent assistance. The generative AI models (also referred to as foundational models) may be pre-trained on large datasets to develop broad capabilities. Further, parameter efficient fine tuning (PEFT) models, such as but not limited to low-rank adapter (LoRA) models, may be used to adapt the foundational models to specific tasks without requiring full retraining. A LoRA model may efficiently modify the model's weights, enabling task-specific adaptations while preserving general capabilities of the foundational model.

While LoRA model provides an efficient method for adapting generative AI models to various tasks, the deployment of multiple LoRA models associated with a single foundational model presents significant challenges on embedded devices. For example, each LoRA model may be trained independently, leading to different quantization parameters for each task. The different quantization parameters may require the generation of separate frozen computation graphs and binary files for each LoRA model, which increases memory usage, compilation effort, and task-switching latency. In some approaches, the architecture may be implemented on a server, because deployment of the architecture on a device may be infeasible due to constraints related to memory capacity, power consumption, and latency, which may be exacerbated by the presence of multiple foundation models. Such on-device implementation and inference may be contrary to the principles underlying PEFT, thereby defeating the intended purpose. A quantization process may reduce memory consumption and improve processing speed by allowing the LoRA model to execute entirely in integer precision during inference. However, when multiple LoRA models are associated with a single foundational model, each LoRA model may use distinct quantization parameters, which may result in separate frozen computation graphs and binary files for each LoRA model. The process may involve compiling separate frozen computation graphs and binaries for each LoRA model, increasing memory consumption, task-switching latency, and deployment complexity.

Further, some quantization workflows, such as post-training quantization (PTQ) or quantization-aware training (QAT), may treat each LoRA model independently. The workflows may not provide a scalable mechanism to unify the quantization parameters across multiple LoRA models, leading to the need to generate separate computation graphs and binary files for each LoRA model. Generating separate graphs and binaries may significantly increase deployment costs, redundant memory storage, task-switching latency, and compilation efforts. Even deploying just two LoRA models may double the memory consumption and task-switching overhead. In large-scale deployments, where dozens of LoRA models may be (such as in multimodal or enterprise-scale AI systems), such inefficiencies may become unsustainable.

Further, some approaches may treat each LoRA model independently, resulting in several significant drawbacks. These drawbacks may include increased memory usage due to the use of separate frozen computation graphs and binary files for each LoRA model, task-switching latency when switching between tasks, and complicated and time-consuming compilation processes. In edge devices with limited resources, these inefficiencies may become even more problematic. Moreover, the inability to harmonize quantization parameters across multiple LoRA models may affect deployment. This limitation may reduce scalability and efficiency, particularly in large-scale or multimodal AI systems. Hence, such systems often use multiple LoRA models for different tasks and may not have a single graph on the embedded device for multiple LoRAs or tasks.

Hence, there is a need for improved security mechanisms that overcome the above-mentioned and other related problems.

### SUMMARY

In accordance with an aspect of the disclosure, a method for generating a task-specific output using a single quantized model graph for a plurality of parameter efficient fine tuning (PEFT) models in a generative artificial intelligence (AI) system, includes: obtaining a base model that is pre-trained to perform a plurality of generative AI tasks corresponding to the plurality of PEFT models; performing a quantization sensitivity analysis across the plurality of PEFT models to obtain a quantization sensitivity score (QSS) corresponding to each PEFT model from among the plurality of PEFT models; selecting a quantization-sensitive PEFT model from among the plurality of PEFT models based on a corresponding QSS; determining a fixed quantization configuration including a scale parameter and a zero-point parameter based on the selected quantization-sensitive PEFT model; adjusting one or more weights associated with the plurality of PEFT models based on the fixed quantization configuration to obtain an adjusted plurality of PEFT models; generating a single quantized model graph including the base model and the fixed quantization configuration, wherein the single quantized model graph allows dynamic selection from among the adjusted plurality of PEFT models; and performing inference by selecting any one of the adjusted plurality of PEFT models and generating the task-specific output using the single quantized model graph.

The method may include performing preprocessing on each of the plurality of PEFT models before deployment to adjust the one or more weights.

The one or more weights may be adjusted using a knowledge distillation (KD) loss-based fine-tuning process.

The one or more weights may be adjusted using a knowledge distillation process, and the knowledge distillation process may include minimizing a divergence metric between an output distribution generated by a PEFT model and an output distribution generated by a quantization-constrained version of the PEFT model.

The one or more weights may be adjusted by applying a task-specific loss to each PEFT model from among the plurality of PEFT models, and the task-specific loss may include at least one from among a cross-entropy loss, a regression loss, and a classification loss.

The one or more weights may be adjusted using a teacher-student knowledge distillation framework including a full-precision PEFT model that operates as a teacher model and a quantization-constrained PEFT model that operates as a student model.

A PEFT model having a highest QSS from among the plurality of PEFT models may be selected as the quantization-sensitive PEFT model.

The one or more weights may be adjusted prior to execution of the plurality of PEFT models, and the adjusted one or more weights may be used to perform the inference without further adjustment.

The single quantized model graph may be configured to support runtime switching among the plurality of PEFT models.

The inference may be performed by using at least one from among an edge device, a mobile neural processing unit (NPU), a cloud accelerator, and an agent-based device.

The plurality of generative AI tasks may include at least one from among a language generation task, a speech synthesis task, an image generation task, a visual recognition task, a segmentation task, and a multimodal reasoning task.

In accordance with an aspect of the disclosure, an electronic device for generating a task-specific output using a single quantized model graph for a plurality of parameter efficient fine tuning (PEFT) models using generative artificial intelligence (AI), includes: at least one processor; and a memory storing instructions which, when executed by the at least one processor, cause the electronic device to: obtain a base model that is pre-trained to perform a plurality of generative AI tasks corresponding to the plurality of PEFT models; perform a quantization sensitivity analysis across the plurality of PEFT models to obtain a quantization sensitivity score (QSS) corresponding to each PEFT model from among the plurality of PEFT models; select a quantization-sensitive PEFT model from among the plurality of PEFT models based on a corresponding QSS; determine a fixed quantization configuration including a scale parameter and a zero-point parameter based on the selected quantization-sensitive PEFT model; adjust one or more weights associated with the plurality of PEFT models based on the fixed quantization configuration to obtain an adjusted plurality of PEFT models; generate a single quantized model graph including the base model and the fixed quantization configuration, wherein the single quantized model graph allows dynamic selection from among the adjusted plurality of PEFT models; and perform inference by selecting any one of the adjusted plurality of PEFT models and generating the task-specific output using the single quantized model graph.

The instructions, when executed by the at least one processor, may further cause the electronic device to perform preprocessing on each PEFT model from among the plurality of PEFT models before deployment to adjust the one or more weights.

The instructions, when executed by the at least one processor, may further cause the electronic device to adjust the one or more weights using a knowledge distillation (KD) loss-based fine-tuning process.

The instructions, when executed by the at least one processor, may further cause the electronic device to adjust the one or more weights using a knowledge distillation process, and the knowledge distillation process may include minimizing a divergence metric between an output distribution generated by a PEFT model and an output distribution generated by a quantization-constrained version of the PEFT model.

The instructions, when executed by the at least one processor, may further cause the electronic device to adjust the one or more weights by applying a task-specific loss to each PEFT model from among the plurality of PEFT models, and the task-specific loss may include at least one from among a cross-entropy loss, a regression loss, and a classification loss.

The instructions, when executed by the at least one processor, may further cause the electronic device to adjust the one or more weights using a teacher-student knowledge distillation framework including a full-precision PEFT model that operates as a teacher model and a quantization-constrained PEFT model that operates as a student model.

The instructions, when executed by the at least one processor, may further cause the electronic device to select a PEFT model associated with a highest QSS from among the plurality of PEFT models as the quantization-sensitive PEFT model.

The instructions, when executed by the at least one processor, may further cause the electronic device to adjust the one or more weights prior to execution of the plurality of PEFT models, and
wherein the adjusted one or more weights are used to perform the inference without further adjustment.

The single quantized inference graph may be configured to support runtime switching among the plurality of PEFT models.

The instructions, when executed by the at least one processor, may further cause the electronic device to perform the inference using at least one from among an edge device, a mobile neural processing unit (NPU), a cloud accelerator, and an agent-based device.

The plurality of generative AI tasks may include at least one of a language generation task, a speech synthesis task, an image generation task, a visual recognition task, a segmentation task, and a multimodal reasoning task.

### BRIEF DESCRIPTION OF THE DRAWINGS

The above and other features, aspects, and advantages of certain embodiments of the present disclosure will be more apparent from the following description taken in conjunction with the accompanying drawings, in which:

FIG. 1 illustrates a block diagram of an architecture depicting functioning of Low-Rank Adapter (LoRA) models, in accordance a comparative example;

FIG. 2 illustrates a process of compiling and deploying a trained generative AI model on an embedded device, in accordance with an embodiment of the present disclosure;

FIG. 3 shows deployment process of generative AI model within the embedded device, in accordance with an embodiment of the present disclosure;

FIG. 4 illustrates quantization and compilation process of a quantized generative model, in accordance with an embodiment of the present disclosure;

FIG. 5 illustrates an example environment depicting a system for generating a task-specific output using a single quantized model graph, in accordance with an embodiment of the present disclosure;

FIG. 6 illustrates a block diagram of the system for generating the task-specific output using the single quantized model graph, in accordance with an embodiment of the present disclosure;

FIG. 7 illustrates a process flow for determining a fixed quantization configuration, in accordance with an embodiment of the present disclosure;

FIG. 8 illustrates an example implementation of the fixed quantization configuration using a vendor-dependent platform, in accordance with an embodiment of the present disclosure;

FIG. 9 illustrates an example implementation of the fixed quantization configuration using a chipset-agnostic framework, in accordance with an embodiment of the present disclosure;

FIG. 10 illustrates extending implementation of the system to many LoRAs, in accordance with an embodiment of the present disclosure;

FIG. 11 illustrates a flow diagram for generating the task-specific output using the single quantized model graph, in accordance with an embodiment of the present disclosure;

FIGS. 12A and 12B illustrate a process flow of a method for generating the task-specific output using the single quantized model graph, in accordance with an embodiment of the present disclosure;

FIG. 13 illustrates an example use case for wallpaper generation, in accordance with an embodiment of the present disclosure;

FIG. 14 illustrates an example use case for in-out painting, in accordance with an embodiment of the present disclosure; and

FIG. 15 illustrates a use case related to shared quantization parameters, in accordance with an embodiment of the present disclosure.

### DETAILED DESCRIPTION

For the purpose of promoting an understanding of the principles of the present disclosure, reference will now be made to the various embodiments, and specific language will be used to describe the same. It will nevertheless be understood that no limitation of the scope of the present disclosure is thereby intended, such alterations and further modifications in the illustrated system, and such further applications of the principles of the present disclosure as illustrated therein, being contemplated as would normally occur to one skilled in the art to which the present disclosure relates.

It will be understood by those skilled in the art that the foregoing general description and the following detailed description are explanatory of the present disclosure and are not intended to be restrictive thereof.

As used herein, phrases such as “one or more features” or “one or more elements,” “at least one feature,” or “at least one element” may refer to a feature or element that is present or used only once, or is present or used a plurality of times. Furthermore, the use of the terms “one or more” or “at least one” does not preclude there being none of that feature or element, unless otherwise explicitly specified by language, including, but not limited to, “there needs to be one or more . . . ” or “one or more elements are required.”

Reference is made herein to some “embodiments.” It should be understood that an embodiment is an example of a possible implementation of any features and/or elements of the present disclosure. Some embodiments are described for the purpose of explaining one or more of the potential ways in which the specific features and/or elements of the present disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments, and therefore should not necessarily be taken as limiting to the present disclosure.

The terms “comprises”, “comprising”, or any other variations thereof, are intended to cover a non-exclusive inclusion, such that a process or method that comprises a list of steps does not necessarily include only those steps, and may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate”, as well as the derivatives thereof, encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C; A and B; A and C; B and C; and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” may mean one or more. Accordingly, a set of items may be a single item or a collection of two or more items.

According to embodiments, multiple functions described below may be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data may be permanently stored and media where data may be stored and later overwritten, such as a rewritable optical disc or an erasable memory device.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Further, skilled artisans will appreciate those elements in the drawings that are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

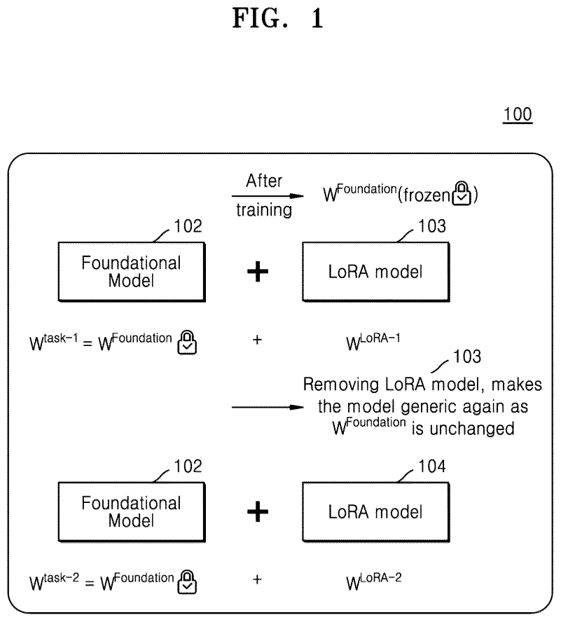

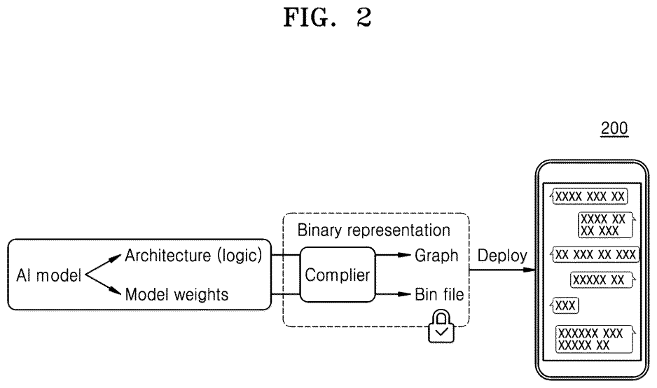

For the sake of clarity, the first digit of a reference numeral of each component of the present disclosure is generally indicative of a figure in which the corresponding component is illustrated. For example, reference numerals starting with digit “1” are shown at least in FIG. 1. Similarly, reference numerals starting with digit “2” are shown at least in FIG. 2. Further, similar reference numerals are used to represent similar components in the Drawings.

It should be noted that the terms “evidence” and “at least one proof of evidence” are used interchangeably throughout the description and the drawings. Further, the terms “policy” and “one or more policy configurations” have been used interchangeably throughout the description and the drawings.

As discussed above, generative artificial intelligence (AI) models, such as large language models (LLMs) and large vision models (LVMs), may be pre-trained on large datasets to develop broad capabilities. Further, parameter efficient fine tuning (PEFT) models, such as but not limited to low-rank adapter (LoRA) models, may be used to adapt the foundational models to specific tasks without requiring full retraining.

FIG. 1 illustrates a block diagram 100 of an architecture showing the functioning of low-rank adapter (LoRA) models, according to embodiments. As shown in FIG. 1, a foundational model 102 may be trained using a large, generic dataset. After training, the weights (denoted as W^{foundation}) of the foundational model 102 may be frozen. The frozen weights of the foundational model 102 are adapted using a LoRA model 103 associated with a first task, resulting in task-specific weights W^{task-1}. The relationship may be expressed according to Equation 1 below:

$${W}^{task - 1} = {W}^{foundation} + {W}^{LoRA - 1} \qquad ( Equation 1 )$$

In Equation 1, W^{LORA model-1} may denote weights of LoRA model 103.

If the LoRA model 103 is removed, the underlying weights W^{foundation} remains unchanged, preserving general-purpose nature of the foundational model 102. Similarly, a LoRA model 104 may be added to adapt the model for a second task, resulting in task-specific weights W^{task-2}, which may be expressed according to Equation 2 below:

$${W}^{task - 2} = {W}^{foundation} + {W}^{LoRA - 2} , \qquad ( Equation 2 )$$

In Equation 2, W^{LoRA-2} may denote weights of LoRA model 104.

Thus, the weights of the foundational model 102 may remain intact as LoRA models are added or removed. This modular approach may enable task-specific adaptation while preserving general capabilities of the foundational model 102 across different tasks.

FIG. 2 illustrates a process 200 of compiling and deploying a trained generative AI model on an embedded device, in accordance with embodiments. As shown, the trained model may be converted into a frozen computation graph and binary file, which may be stored in a memory of a device (e.g., an embedded device). During inference (e.g., while performing an inference operation), a processor may retrieve the frozen computation graph and binary file from the memory to perform computations and generate deterministic outputs. The process 200 may work efficiently for a single generative AI model; however, the process 200 may be increasingly inefficient when multiple LoRA models are deployed, each requiring a separate respective frozen graph and binary file. This challenge is further exacerbated in edge environments, where deployments may be constrained by limited memory, processing power, and energy availability. To overcome these challenges, quantization may be employed to reduce precision of the model weights and activations. The quantization may convert floating-point values (e.g., 32-bit floating point (FP32)) into low-bit integer representations (e.g., 8-bit integer (INT8) or 4-bit integer (INT4)). The process may reduce memory requirements and accelerates inference by enabling computations to run in integer precision. However, this quantization may present challenges, as discussed in greater detail above.

When an AI model is quantized before deployment, the weights may be converted into integer bit precision using the quantization parameters (scale and zero point). The conversion may occur before deployment in order to reduce memory usage. The quantized weights may stored in the form of a model binary (as shown in FIG. 2). The fundamental computation can be expressed according to Equation 3 below:

$$y = f ( w \cdot x ) \qquad ( Equation 3 )$$

In Equation 3, x may denote an input, w may denote a weight, f may denote an activation function, and y may denote an activation map. Unlike weights w, which may be quantized and fixed before deployment, the activation maps y may be dynamic because they may depend on varying inputs x during inference. As a result, activation maps y may not be pre-quantized, and must instead be quantized on-the-fly during runtime (e.g., during inference or while inference operations are performed). Therefore, the quantization parameters (e.g., scale and zero point) may be embedded directly into the frozen computation graph. Thus, activations are quantized at runtime, and the computation in Equation 3 may execute entirely in integer precision, providing maximum latency savings.

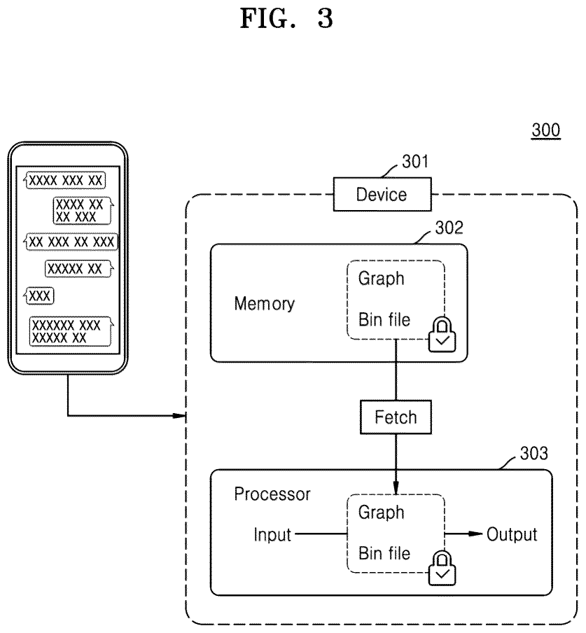

FIG. 3 shows deployment process 300 of a generative AI model within an embedded device 301, according to an embodiment. As illustrated in FIG. 3, a processor 303 may fetch the quantized computation graph and binary from a memory 302 and apply the embedded quantization parameters during inference to ensure activations are quantized dynamically, while the weights remain pre-quantized.

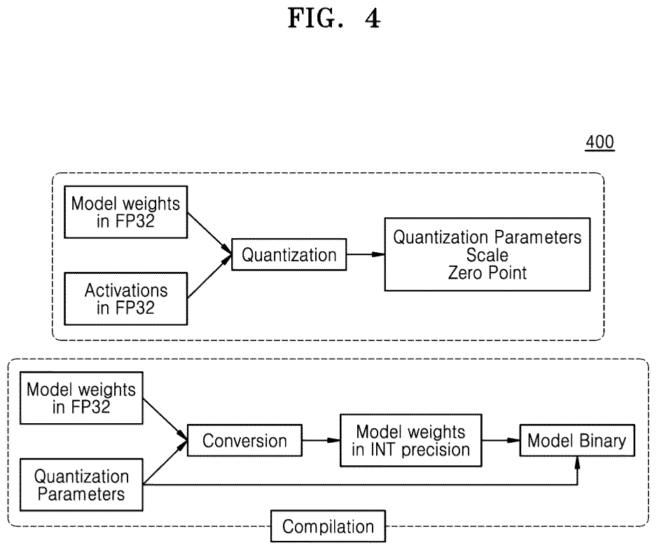

FIG. 4 illustrates a quantization and compilation process 400 of a quantized generative AI model, in accordance with prior art. As illustrated in FIG. 4, initially, model weights, stored in floating-point precision (FP32), are quantized into integer precision (e.g., INT8 or INT4) using quantization parameters. The parameters may be embedded in the computation graph and compiled into the binary form for deployment.

While LoRA models may provide an efficient method for adapting generative AI models to various tasks, the deployment of multiple LoRA models associated with a single foundational model may present significant challenges on embedded devices, as discussed in greater detail above. Therefore, embodiments of the present disclosure may provide techniques for deploying multiple parameter efficient fine tuning (PEFT) models, such as but not limited to low-rank adapter (LoRA) models, each of which may have or correspond to different quantization configurations (which may be referred to as quantization parameters), within a unified computation graph. By harmonizing the quantization parameters across multiple LoRA modules, embodiments of the present disclosure may enable the deployment of the PEFT models incorporated within a single computation graph. Embodiments of the present disclosure may provide a unified framework that reduces memory usage, eliminates redundant task-switching overhead, simplifies compilation process, and improves deployment efficiency, particularly for resource-constrained edge devices. Thus, embodiments of the present disclosure may provide a scalable and efficient mechanism for deploying generative artificial intelligence (AI) models with multiple PEFT models in edge and agentic environments.

Embodiments of the present disclosure are described below in detail with reference to the accompanying drawings.

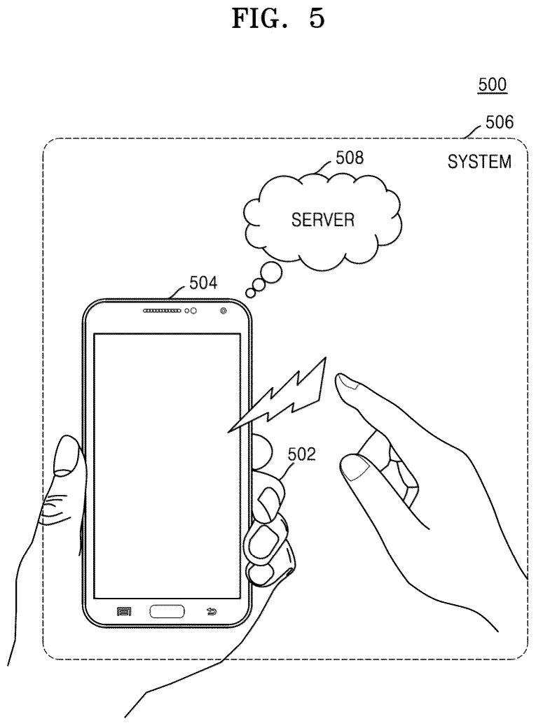

FIG. 5 illustrates an example environment depicting a system for generating a task-specific output using a single quantized model graph, in accordance with an embodiment of the present disclosure.

Referring to FIG. 5, the environment 500 depicts an implementation of the system 506. According to embodiments, the system 506 may include, or be included in, an electronic device 504. Although the example illustrated in FIG. 5 includes a single electronic device 504, embodiments are not limited thereto. For example, in some embodiments, there may be more than one electronic device associated with the user 502, which may be in a connected environment, which may mean for example that the devices may be in communication with each other using one or more communication networks. Accordingly, the present disclosure interchangeably refers to the electronic device 504, or one or more electronic devices 504, to imply various scenarios. As an example, the system 506 may be implemented on the one or more electronic devices 504, which may mean for example that the system 506 may be implemented in a distributed manner in such one or more electronic devices 504. The one or more electronic devices 504 may include a smartphone, tablet, laptop, television, or wearable device. As an example, the system 506 may be implemented on a server 508, which may be in communication with the one or more electronic devices 504 using a communication network. The system 506, either when implemented in the single electronic device 504 or a plurality of electronic devices 504 and/or the server 508 associated with a user, may be configured to generate the task-specific output using a single quantized model graph using the electronic devices 504 in the environment 500.

In an embodiment, the system 506 may include software, hardware, a combination of software and hardware, an in-built application on the electronic device 504, or an application to be installed and operated on one or more electronic devices 504 in communication with a network interface. The system 506 may also be accessible at the electronic device 504 using the server 508 (e.g., a cloud-based server), communicating remotely with the electronic device 504.

When the system 506 is located outside the electronic device 504, the network interface may be configured to provide network connectivity and enable communication between the system 506 and the electronic device 504. The network connectivity may be provided using a wireless connection or a wired connection. For example, the network connectivity may be provided using cellular technology, such as 3rd Generation (3G), 4th Generation (4G), 5th Generation (5G), pre-5G, 6th Generation (6G), Bluetooth, Local Area Network (LAN), Wi-Fi, cable, or any other wired/wireless communication technology.

In an embodiment, the system 506 may be configured to obtain a base model pre-trained to perform a plurality of generative artificial intelligence tasks using a plurality of PEFT models.

For example, the plurality of generative AI tasks may include at least one of a language generation task, a speech synthesis task, an image generation task, a visual recognition task, a segmentation task, and a multimodal reasoning task.

For example, the base model may correspond to a pre-trained generative AI model configured to perform multiple tasks across modalities, for instance, text, vision, and speech. The base model may include a comprehensive set of parameters and may operate as a shared backbone across applications. The base model may be deployed on-device (e.g., on at least one electronic device 504) or in the cloud (e.g., on the server 508) and may be reused without retraining for each new task. For example, the base model may be deployed on a smartphone embedding a pre-trained multimodal transformer for voice assistants, image captioning, and text generation.

For example, each of the plurality of PEFT models may correspond to a lightweight, task-specific fine-tuning model that interfaces with the base model without modifying core parameters of the PEFT model. The PEFT model may enable rapid deployment of new features with low memory and compute requirements, suitable for constrained devices. The PEFT models may be dynamically loaded or swapped based on the task or application context. For example, a LoRA model on a wearable device may enable personalized health insights from voice input using the base model.

In an embodiment, the system 506 may be configured to perform a quantization sensitivity analysis across the plurality of PEFT models to obtain a quantization sensitivity score (QSS) corresponding to each PEFT model from among the plurality of PEFT models.

For example, the QSS may correspond to a numerical metric assigned to the PEFT model that indicates robustness or susceptibility to accuracy degradation of the PEFT model under quantization constraints. The QSS may be computed based on divergence metrics, loss in accuracy, or performance degradation observed when the model is subjected to reduced-precision formats.

In an embodiment, the system 506 may be configured to select a quantization-sensitive PEFT model from among the plurality of PEFT models based on a corresponding QSS (e.g., a QSS corresponding to the quantization-sensitive PEFT model). The selection may be performed to ensure optimal performance and compatibility when deploying models in quantized environments, such as edge devices or low-resource systems.

For example, the quantization-sensitive PEFT model may be specifically designed or adapted to maintain performance when integrated with the base model. The quantization-sensitive PEFT model may undergo pre-conditioning, scaling, or harmonization processes to align its parameter distribution with the quantized weight space of the base model, for example, a LoRA module optimized for 4-bit integer inference on a smartphone neural processing unit (NPU), enabling low-latency voice command recognition.

In an embodiment, the system 506 may be configured to determine a fixed quantization configuration comprising a scale parameter and a zero-point parameter based on the selected quantization-sensitive PEFT model. For example, the fixed quantization configuration may correspond to a predetermined set of parameters used to convert floating-point values into low-precision integer representations for inference. The configuration may be determined based on statistical properties of the selected quantization-sensitive PEFT model. For example, a 4-bit quantization setup for a LoRA module on the electronic device that performs computing at edge of a network, where the scale parameter may be 0.02 and the zero-point parameter may be 128, enabling efficient execution on an embedded neural accelerator.

In an embodiment, the system 506 may be configured to adjust one or more weights of each of the plurality of PEFT models (e.g., each PEFT model of the plurality of PEFT models) to conform to the fixed quantization configuration. For example, the one or more weights of a PEFT model may correspond to numerical parameters within the PEFT model that are trainable and directly influence the output of the PEFT model. The one or more weights may include scalars, vectors, matrices, or tensors that correspond to connections, transformations, or adaptation layers within the PEFT architecture. For example, changing the one or more weights in the LoRA module on a voice assistant model to better recognize user commands without retraining the base model.

In an embodiment, the system 506 may be configured to generate the single quantized inference graph incorporating the base model with the fixed quantization configuration and enabling dynamic selection of any one of the adjusted plurality of PEFT models. For example, the single quantized inference graph may include the base model and the fixed quantization configuration, and the single quantized inference graph may dynamic selection from among the adjusted plurality of PEFT models.

For example, the single quantized inference graph may correspond to a computational graph representing a machine learning model in which operations and data are converted from high-precision formats (e.g., float32) to lower-bit formats (e.g., INT8). The single quantized inference graph may enable efficient execution on hardware platforms with limited computational resources by performing computations in reduced precision.

In an embodiment, the system 506 may be configured to generate inference (e.g., to perform inference operations to generate inference outputs) by selecting any one of the adjusted plurality of PEFT models at runtime and generating the task-specific output using the single quantized inference graph.

In an example scenario, the electronic device 504 (e.g., a smartphone) ma include the plurality of PEFT models, each adapted for a respective generative artificial intelligence task, including, but not limited to, voice-to-text transcription, language translation, and sentiment analysis. At runtime (e.g., when performing inference operations), the electronic device 504 may select a particular PEFT model corresponding to a requested task, for example, language translation. The selected PEFT model is executed utilizing a single shared quantized inference graph derived from the pre-trained base model, enabling efficient inference by reducing memory usage and computational overhead relative to deploying separate full models for each task.

In an embodiment, the system 506 may be configured to pre-process each of the plurality of PEFT models prior to deployment (e.g., prior to runtime) to conform the one or more associated weights to the fixed quantization configuration.

In an embodiment, the system 506 may be configured to adjust the one or more weights of each of the plurality of PEFT models using a-knowledge distillation (KD) loss-based fine-tuning process. For example, the KD loss-based fine-tuning process may correspond to a training method that minimizes the KD loss between an output distribution of a pre-trained base model and a fine-tuned model. This process may guide the fine-tuned model to closely approximate the probabilistic behavior of the base model while adapting to a specific task.

In an embodiment, the system 506 may be configured to adjust the one or more weights using a KD process that includes minimizing a divergence metric (e.g. L2 loss) between an output distribution generated by the corresponding PEFT model and an output distribution generated by a quantization-constrained version of the PEFT model.

In an embodiment, the system 506 may be configured to adjust the one or more weights further by applying a task-specific loss to each of the plurality of PEFT models. For example, the task-specific loss may be selected from a group of losses consisting of a cross-entropy loss, a regression loss, and a classification loss.

In an embodiment, the system 506 may be configured to adjust the one or more weights using a teacher-student knowledge distillation framework. For example, according to the teacher-student knowledge distillation framework, a full-precision PEFT model may operate as a teacher model, and a quantization-constrained PEFT model may operate as a student model.

In an embodiment, the system 506 may be configured to select a quantization-sensitive PEFT model having (or corresponding to or associated with) a highest QSS among a plurality of QSSs associated with the plurality of PEFT models as the quantization-sensitive PEFT model.

In an example scenario, a smartwatch may include three LoRA-based PEFT models (e.g., a model A, a model B, and a model C) for voice recognition, each of which may be trained slightly differently. Before deployment, each model may be quantized to INT4 precision and evaluated. The model A may be associated with a 3% drop in accuracy (e.g., a relatively high QSS), the model B may be associated with a 1% drop in accuracy (e.g., a relatively low QSS), and the model C may be associated with no drop in accuracy (e.g., no measurable QSS). The system 506 may select the model A (e.g., the model having the highest QSS) as the quantization-sensitive PEFT model for efficient and accurate voice processing on the smartwatch.

In an embodiment, the system 506 may be configured to adjust the one or more weights prior to execution of the plurality of PEFT models, and the adjusted one or more weights may be employed during runtime without further adjustment.

For example, the single quantized inference graph may be configured to support runtime switching among the plurality of PEFT models.

In an embodiment, the system 506 may be configured to execute the inference (e.g., to perform the inference operations) on at least one from among an edge device, a mobile Neural Processing Unit (NPU), a cloud accelerator, and an agent-based device.

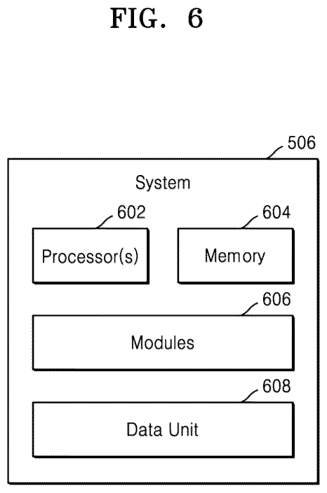

FIG. 6 illustrates a block diagram of the system 506 for generating the task-specific output using the single quantized model graph, in accordance with an embodiment of the present disclosure.

In an embodiment, the system 506 may include at least a processor 602, a memory 604, a plurality of modules 606, and a data unit 608. The processor 602, the memory 604, the plurality of modules 606, and the data unit 608 are communicably coupled with each other

In an embodiment, the at least one processor 602 may be in communication with the memory 604. The at least one processor 602 may be a single processing unit or several units, all of which could include multiple computing units. The at least one processor 602 may be implemented as one or more microprocessors, microcomputers, microcontrollers, digital signal processors, central processing units, state machines, logic circuitries, and/or any devices that manipulate signals based on operational instructions. Among other capabilities, the at least one processor 602 may be configured to fetch and execute computer-readable instructions and data stored in the memory 604.

In an embodiment, the memory 604 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an embodiment, the plurality of modules 606 may be configured to generate the task-specific output using the single quantized model graph. The plurality of modules 606 may include the base model and the plurality of PEFT models.

In some embodiments, the plurality of modules 606 may include a set of instructions that may be executed to cause the system 500 to perform any one or more of the methods or processes described in the present disclosure. The system 500 may operate as a standalone device or may be connected, e.g., using a network, to other computer systems or peripheral devices. Further, although FIG. 6 illustrates an example including a single processing unit, the term “processing unit” may also include any collection of processing units, implemented across the system 500 that individually or jointly execute a set, or multiple sets, of instructions to perform one or more computer functions.

In an embodiment, the plurality of modules 606 may be implemented using one or more artificial intelligence (AI) units that may include a plurality of neural network layers. Examples of neural networks include, but are not limited to, convolutional neural network (CNN), deep neural network (DNN), recurrent neural network (RNN), and restricted Boltzmann machine (RBM). According to embodiments, learning may refer to a method or process for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI unit may be performed through the non-volatile memory, the volatile memory, and the processor. The processor 602 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor, such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

In an embodiment, the data unit 608 may include routines, programs, objects, components, data structures, and the like, which may perform tasks or implement data types. The data unit 608 may also be implemented as signal processor(s), state machine(s), logic circuitries, and/or any other device or component that manipulates signals based on operational instructions. Further, the data unit 608 may be implemented in hardware, instructions executed by a processing unit, or by a combination thereof. The processing unit may comprise a processor, such as the at least one processor 602, a state machine, a logic array, or any other suitable device capable of processing instructions. The processing unit may be a general-purpose processor that executes instructions to cause the general-purpose processor to perform the required tasks, or the processing unit can be dedicated to performing the required functions. In another embodiment of the present disclosure, the data unit 608 may be machine-readable instructions (software) that, when executed by the processor 602, perform any of the described functionalities.

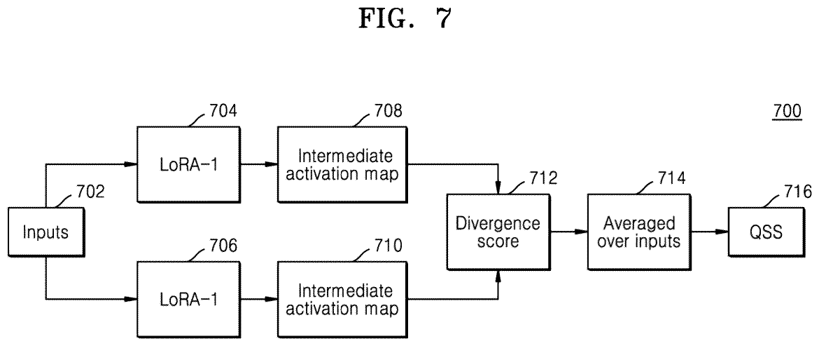

FIG. 7 illustrates a process flow 700 for determining the fixed quantization configuration, in accordance with an embodiment of the present disclosure.

As shown in FIG. 7, to determine the fixed quantization configuration, the system 500 may be configured to perform sensitivity analysis and derive optimal quantization parameters.

As shown, input data 702 may be simultaneously processed by two versions of a LoRA adapter, referred to herein as LoRA-1 704 (which may operate in FP-32) and LoRA-1 706 (which may operate in INT), corresponding to full-precision and quantized variants, respectively. The LoRA-1 704 may be a full-precision variant that operates using 32-bit floating-point (FP32) arithmetic. The LoRA-1 704 may retain highest numerical precision and is typically used during training or high-fidelity inference. Further, the LoRA-1 706 may be the quantized variant that operates using integer-based arithmetic (e.g., INT8). Each version of LoRA-1 (may generate an output, which may for example be referred to as an intermediate activation map. For example, LoRA-1 704 may generate an intermediate activation map 708 as an output, and LoRA-1 706 may generate an intermediate activation map 710 as an output. The intermediate activation maps 708 and 710 may be used to analyze how the model processes inputs at various stages.

The intermediate activation maps 708 and 710 may be evaluated using a divergence scoring module 712, which may compute a divergence score between the intermediate activation maps 708 and 710. The divergence scores may be averaged 714 over the input data 702 to yield the QSS 716.

In an embodiment, the QSS may be defined as according to Equation 4 below:

$$QSS = {E}_{x} [ D ( f ( x ; w ) ‖ f ( x ; \tilde{w} ) ) ] \qquad ( Equation 4 )$$

In Equation 3, f(x; w) and f(x; \tilde{w}) be the output of LoRA and quantized LoRA, respectively for a given input x. In addition, Ex may denote expectation over the data x, and D(·∥·) may denote suitable divergence between the two output distributions.

In an embodiment, a lower value of the QSS may indicate reduced sensitivity to quantization. The system 500 may be configured to compute QSS using each version of LoRA adapter (e.g., each of LoRA-1 704 and LoRA-1 706), and identify the version with the maximum QSS, which is considered most quantization-sensitive. The quantization parameters derived from one of the versions of the LoRA adapter (e.g., one of LoRA-1 704 and LoRA-1 706) may be selected as the fixed quantization parameters for the system 500.

In an embodiment, if the LoRA adapters may exhibit comparable sensitivity to quantization, the system 500 may employ a fallback strategy which may be referred to as a unified LoRA. The fallback strategy may involve merging weight distributions of the LoRA adapter into a unified distribution to derive global quantization parameters.

As an example, there may be N LoRA adapters having weights W which may be expressed according to Equation 5 below

$$W = \{ {w}_{1} , {w}_{2} , ... {w}_{N} \} \qquad ( Equation 5 )$$

The merged weight distribution W_{merged} may be expressed according to Equation 6 below:

$${W}_{merged} = {⋃}_{i = 1}^{N} {w}_{i} \qquad ( Equation 6 )$$

The quantization parameters may then be extracted from the merged weight distribution using the PTQ approach.

In an embodiment, the system 500 may implement the fixed quantization configuration by enforcing the derived quantization parameters either from the most sensitive LoRA or from the unified LoRA distribution, across other LoRA adapters (e.g., LoRA-1 704 and LoRA-1 706).

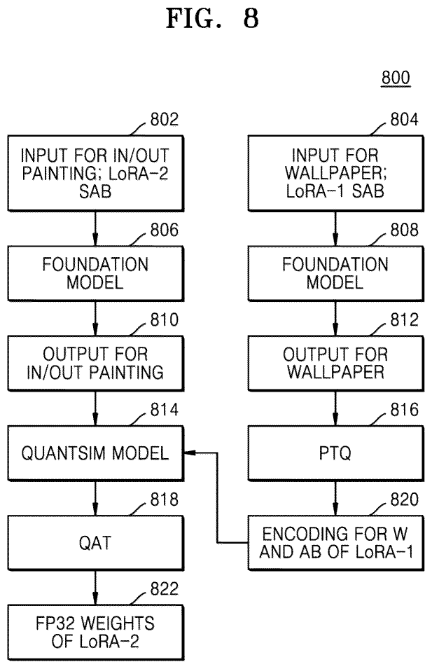

FIG. 8 illustrates an example implementation of the fixed quantization configuration 800 using a vendor-dependent platform, in accordance with an exemplary embodiment of the present disclosure.

As shown in FIG. 8, at step 804, LoRA-1 may be used for wallpaper generation and may serve as an anchor adapter for quantization parameter derivation. At step 802, LoRA-2 may be used for inpainting or out-painting tasks. The parameters may then be applied to the LoRA-2.

The system 500 may be further configured to fine-tune the weights of LORA adapters (e.g., LoRA-1 and LoRA-2) independently, without modifying the weights of the underlying foundation model (e.g., the foundation model 806 and the foundation model 808). Thus, fine-tuning the weights of LoRA adapter without modifying the weights preserves the integrity of the base model while enabling efficient task-specific adaptation through the plurality of PEFT models.

In an embodiment, the fixed quantization parameters derived from LoRA-1 may be enforced across other LoRA adapters, such as LoRA-2, for adjusting the one or more weights of each of the plurality of PEFT models to conform to the fixed quantization configuration. During the adjustment the one or more weights, only the weights of the target LoRA adapters are trained, while the base model remains unchanged.

In an embodiment, at steps 810 and 812, the system 500 may be configured to generate outputs for different tasks, such as in/out-painting and wallpaper generation, using corresponding foundation models with LoRA adapters. At steps 814 to 818, the system 500 may be configured to perform quantization processing for the PEFT models, including quantization simulation, post-training quantization, and quantization-aware training. At steps 820 and 822, the system 500 may be configured to encode LoRA weight matrices (W, A, B) for quantization and to maintain corresponding FP32 weights as reference parameters.

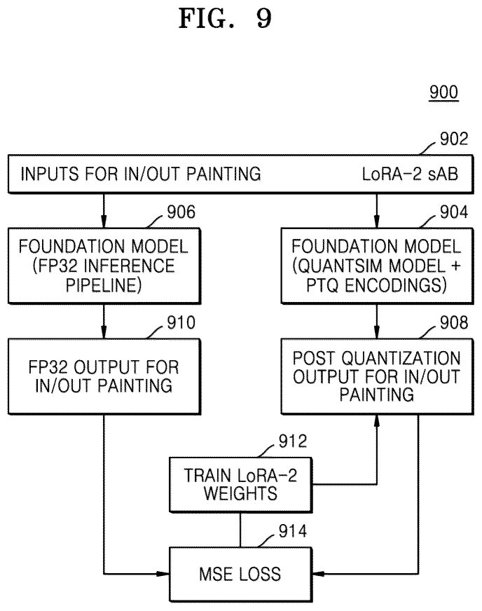

In an embodiment, adjustment of the one or more weights may be either using a vendor-dependent platform, such as AI Model Efficiency Toolkit (AIMET), or a chipset-agnostic framework, as shown in FIG. 9.

In the vendor-dependent platform implementation, a quantization-aware training (QAT) may be used. However, in an embodiment where the system 500 may be implemented natively in the PyTorch framework, a KD-based training pipeline may be employed in conjunction with QAT techniques as explained in FIG. 9.

FIG. 9 illustrates an example implementation 900 of the fixed quantization configuration using the chipset-agnostic framework, in accordance with an embodiment of the present disclosure.

As shown, a quantization simulator model (QuantSim) may be built at step 904 for a foundation model and the LoRA adapter (e.g., LoRA-2) at step 902, which may be tuned or adjusted. The QuantSim model may simulate quantization by applying predefined quantization parameters to the weights of LoRA-2 and generating corresponding outputs for accuracy evaluation. After the quantization parameters, for instance, the PTQ encodings, are derived from a reference adapter (e.g., LoRA-1, used for wallpaper generation), which may be determined or selected according to embodiments the present disclosure based on QSS, these parameters may be supplied to the QuantSim model. The simulator may then quantize LoRA-2 using the PTQ encodings of LoRA-1 and produce quantized outputs at step 908.

In an embodiment, the output of the quantized LoRA-2 may be compared with the output of full-precision counterpart of LoRA-2 at step 914. The full-precision LoRA-2 may operate as a teacher model, while the quantized LoRA-2 may operate as a student model in a teacher-student knowledge distillation framework. The system 500 may compute a mean squared error (MSE) loss between the outputs of the models. Additionally, original training loss associated with the LVM may be incorporated. The system 500 may combine both the KD loss and the original task-specific loss to iteratively update the weights of LoRA-2, thus improving the accuracy of LoRA-2 compared to a baseline quantized LoRA-2.

In an embodiment, at steps 906 to 912, the system 500 may be configured to generate FP32 and quantized outputs of the foundation model for comparison and to train LoRA-2 weights using an MSE-based loss derived from the output differences.

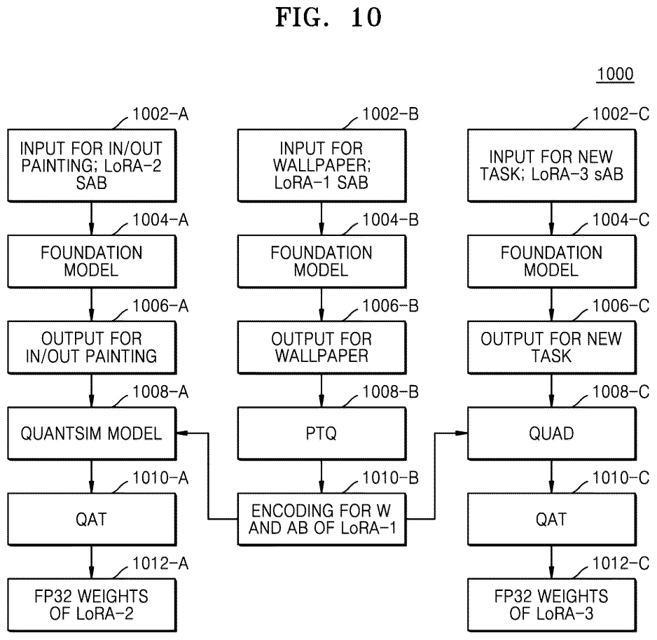

FIG. 10 illustrates extending implementation 1000 of the system 500 to a plurality of new LoRAs (e.g., other than LoRA-2), in accordance with an embodiment of the present disclosure.

As depicted, the system 500 may not be limited to a predefined set of LORA adapters, and instead may be extended to any newly introduced LoRA adapter (e.g., LoRA-3), as shown in step 1002-C, that may be deployed over the base model, such as a latent variable model. According to embodiments, operations 1002-A, 1004-A, 1006-A, 1008-A, 1010-A, 1012-A, 1002-B, 1004-B, 1006-B, 1008-B, and 1010-B may correspond to one or more of operations 802, 804, 810, 814, 818, 822, 804, 808, 812, 816, and 820 illustrated in FIG. 8. The system 500 may be configured to apply the same quantization and fine-tuning methodology to future LoRA adapters, for instance, for new task without requiring changes to the underlying framework as shown in steps 1004-C, 1006-C, 1008-C, 1010-C and 1012-C, the same is not repeated herein for the sake of brevity.

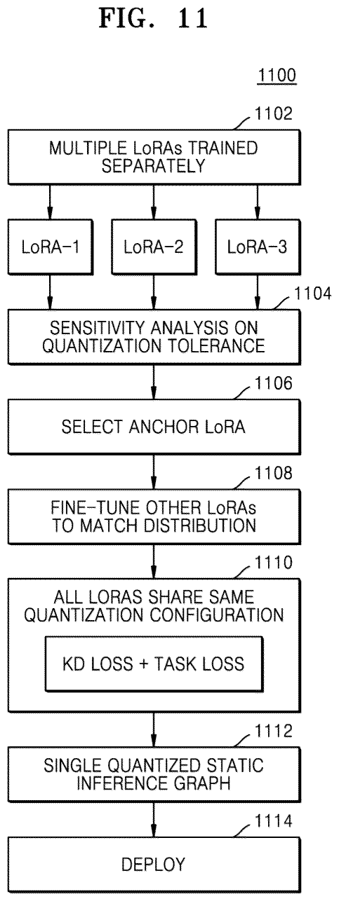

FIG. 11 illustrates a flow diagram 1100 for generating the task-specific output using the single quantized model graph, in accordance with an embodiment of the present disclosure.

At step 1102, the processor 602 may be configured to train the plurality of PEFT models separately, (e.g., to train LoRA-1, LoRA-2, and LoRA-3 separately).

At step 1104, the processor 602 may be configured to perform the quantization sensitivity analysis across the plurality of PEFT models to obtain a QSS corresponding to each PEFT model from among the plurality of PEFT models (e.g., to each of LoRA-1, LoRA-2, and LoRA-3).

In an embodiment, the sensitivity analysis may be performed across all LoRAs to determine which is least tolerant to quantization loss, which may then be considered as the anchor LoRA. Further, fixed quantization parameters may be obtained based on the weight distribution of the anchor LoRA.

At step 1106, the processor 602 may be configured to select the quantization-sensitive PEFT model from among the plurality of PEFT models based on the corresponding QSS (e.g., based on a QSS corresponding to the quantization-sensitive PEFT model) and determine the fixed quantization configuration. Further, a quantization-sensitive PEFT model with the highest QSS among a plurality of QSSs associated with the plurality of PEFT models) may be selected as the quantization-sensitive PEFT model.

At step 1108, the processor 602 may be configured to adjust the one or more weights of each of the plurality of PEFT models (e.g., of each PEFT model from among the plurality of PEFT models) to conform to the fixed quantization configuration.

In an embodiment, all other LoRAs may be fine-tuned to align with the fixed quantization configuration to ensure consistency across the LoRA models. The alignment may be achieved by introducing the KD-based fine-tuning process that penalizes deviations between original outputs and quantization-aligned versions. Additionally, a task-specific loss, such as cross-entropy for classification or regression loss for prediction, may be incorporated to align with the fixed quantization configuration.

At step 1110, the processor 602 may be configured to enable the plurality of the PEFT models to share same fixed quantization configuration.

At step 1112, the processor 602 may be configured to generate the single quantized inference graph incorporating the base model with the fixed quantization configuration and enabling dynamic selection of any of the adjusted plurality of PEFT models.

At step 1114, the processor 602 may be configured to generate inference by selecting any one of the adjusted plurality of PEFT models at runtime and generating the task-specific output using the single quantized inference graph. Further, the inference may be executed on the device selected from the group of devices consisting of the edge device, the mobile NPU, the cloud accelerator, and the agent-based device.

In an embodiment, the processor 602 may be configured to incorporate curriculum learning by initiating alignment with the LoRAs that exhibit lower divergence from the anchor LoRA, progressively extending to more complex LoRAs. In some embodiments, competitive or cooperative tuning strategies may be employed, wherein the LoRAs may interact during distillation to mutually enhance task-specific performance. Further, to ensure stability in quantization, regularization or smoothing techniques may be applied to weight statistics, thereby mitigating abrupt variations that may compromise quantization fidelity. According to embodiments, the training process may further include early stopping or adaptive loss weighting mechanisms, balancing quantization alignment against task performance degradation. Upon successful alignment of all LoRAs to the anchor LoRA's quantization grid, the fixed quantization configuration is established.

In an embodiment, a static, quantized inference graph may be compiled once, enabling dynamic switching between multiple LoRAs at runtime without necessitating graph recompilation or re-quantization. Thus, ensuring consistent inference behavior across platforms and facilitating multi-task deployment using the shared graph.

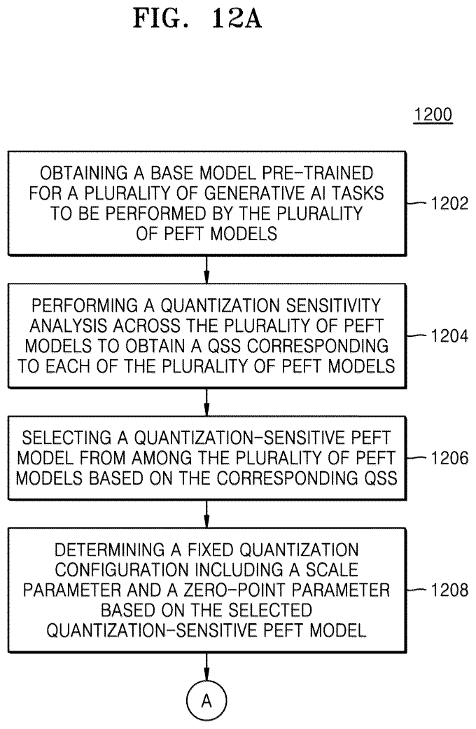

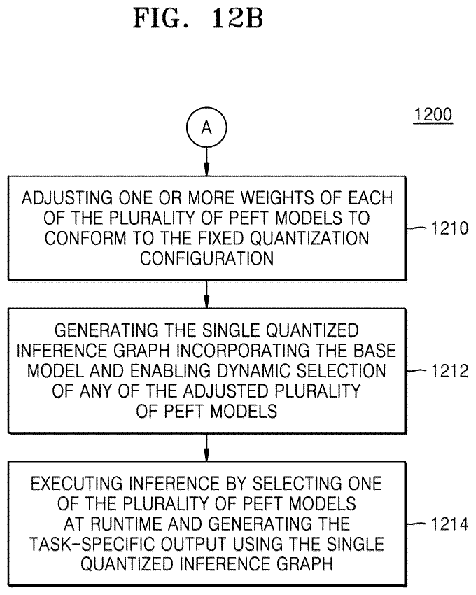

FIGS. 12A-12B illustrate a process flow of a method for generating the task-specific output using the single quantized model graph, in accordance with an embodiment of the present disclosure. The method 1200 may be a computer-implemented method executed, for example, by the system 500. For the sake of brevity, constructional and operational features of the system 500 that are already explained in the description of FIGS. 5-11 are not explained in detail in the description of FIGS. 12A-B.

At step 1202, the method 1200 may include obtaining the base model pre-trained for the plurality of generative AI tasks to be performed by the plurality of PEFT models. For example, the base model may be pre-trained to perform a plurality of generative AI tasks corresponding to the plurality of PEFT models.

For example, the plurality of generative artificial intelligence tasks may include at least one of the language generation task, the speech synthesis task, the image generation task, the visual recognition task, the segmentation task, and the multimodal reasoning task.

For example, the base model may correspond to the pre-trained generative AI model configured to perform multiple tasks across modalities, for example, text, vision, and speech. The base model may include a comprehensive set of parameters and operate as the shared backbone across applications. The base model may be deployed on-device or in the cloud and reused without retraining for each new task. For example, the smartphone may embed the pre-trained multimodal transformer for voice assistants, image captioning, and text generation.

For example, the PEFT model may correspond to the lightweight, task-specific fine-tuning module that interfaces with the base model without modifying core parameters of the PEFT model. The PEFT model may enable rapid deployment of new features with low memory and compute requirements, suitable for constrained devices. The PEFT models may be dynamically loaded or swapped based on the task or application context. For example, the LoRA model on the wearable device may enable personalized health insights from voice input using the base model.

At step 1204, the method 1200 may include performing the quantization sensitivity analysis across the plurality of PEFT models to obtain the QSS corresponding to each PEFT model from among the plurality of PEFT models.

For example, the QSS may correspond to the numerical metric assigned to the PEFT model that indicates robustness or susceptibility to accuracy degradation of the PEFT model under quantization constraints. The QSS may be computed based on divergence metrics, loss in accuracy, or performance degradation observed when the model is subjected to reduced-precision formats.

At step 1206, the method 1200 may include selecting the quantization-sensitive PEFT model from among the plurality of PEFT models based on the corresponding QSS.

For example, the quantization-sensitive PEFT model may correspond to the module that is specifically designed or adapted to maintain performance when integrated with the base model. The quantization-sensitive PEFT model may undergo pre-conditioning, scaling, or harmonization processes to align its parameter distribution with the quantized weight space of the base model. For example, the LoRA model may be optimized for 4-bit integer inference on a smartphone neural processing unit (NPU), enabling low-latency voice command recognition.

At step 1208, the method 1200 may include determining the fixed quantization configuration including the scale parameter and the zero-point parameter based on the selected quantization-sensitive PEFT model.

For example, the fixed quantization configuration may correspond to the predetermined set of parameters used to convert floating-point values into low-precision integer representations for inference. The configuration may be determined based on statistical properties of the selected quantization-sensitive PEFT model. For example, configuration may be determined based on a 4-bit quantization setup for a LoRA module on an edge device, where the scale parameter may be 0.02 and the zero-point parameter may be 128, enabling efficient execution on an embedded neural accelerator.

At step 1210, the method 1200 may include adjusting the one or more weights of each of the plurality of PEFT models to conform to the fixed quantization configuration. For example, step 1210 may include adjusting one or more weights associated with the plurality of PEFT models based on the fixed quantization configuration to obtain an adjusted plurality of PEFT models.

For example, the one or more weights of each of the plurality of PEFT models may correspond to numerical parameters within the PEFT model that are trainable and directly influence the PEFT model's output. The one or more weights may include scalars, vectors, matrices, or tensors that correspond to connections, transformations, or adaptation layers within the PEFT architecture. For example, changing the one or more weights in the LoRA module on a voice assistant model to better recognize user commands without retraining the base model.

At step 1212, the method 1200 may include generating the single quantized inference graph incorporating the base model with the fixed quantization configuration and enabling dynamic selection of any of the adjusted plurality of PEFT models. For example, step 1212 may include generating a single quantized inference graph including the base model and the fixed quantization configuration, and the single quantized inference graph may allow dynamic selection from among the adjusted plurality of PEFT models. In this disclosure, the single quantized inference graph may comprise the base model and a fixed quantization configuration, and may represent a structure in which a plurality of adjusted PEFT models can be selectively applied.

For example, the single quantized inference graph may correspond to the computational graph representing a machine learning model in which operations and data are converted from high-precision formats (such as float32) to lower-bit formats (such as INT8). The single quantized inference graph may enable efficient execution on hardware platforms with limited computational resources by performing computations in reduced precision.

At step 1214, the method 1200 may include generating inference (e.g., performing inference operations or generating inference results) by selecting any one of the adjusted plurality of PEFT models at runtime and generating the task-specific output using the single quantized inference graph.

In an example scenario, the electronic device 504, such as a smartphone, comprises the plurality of PEFT models, each adapted for a respective generative artificial intelligence task, including but not limited to voice-to-text transcription, language translation, and sentiment analysis. At runtime, the electronic device 504 may select a particular PEFT model corresponding to a requested task, for example, language translation. The selected PEFT model is executed utilizing a single shared quantized inference graph derived from the pre-trained base model. Accordingly, embodiments may enable efficient inference by reducing memory usage and computational overhead relative to deploying separate full models for each task.

In an embodiment, the method 1200 may include pre-processing each of the plurality of PEFT models prior to deployment (e.g., prior to runtime) to conform the one or more associated weights to the fixed quantization configuration.

In an embodiment, the method 1200 may include adjusting the one or more weights of each of the plurality of PEFT models using the KD loss-based fine-tuning process.

For example, the KD loss-based fine-tuning process may correspond to a training method that minimizes the KD loss between the output distribution of the pre-trained base model and the fine-tuned model. This process may guide the fine-tuned model to closely approximate the probabilistic behavior of the base model while adapting to a specific task.

In an embodiment, the method 1200 may include adjusting the one or more weights using the knowledge distillation process, which may include minimizing the divergence metric (e.g. L2 loss) between the output distribution generated by the corresponding PEFT model and the output distribution generated by the quantization-constrained version of the PEFT model.

In an embodiment, the method 1200 may include adjusting the one or more weights further by applying the task-specific loss to each of the plurality of PEFT models. For example, the task-specific loss may be selected from the group of losses consisting of the cross-entropy loss, the regression loss, and the classification loss.

In an embodiment, the method 1200 may include adjusting the one or more weights using the teacher-student knowledge distillation framework. In the teacher-student knowledge distillation framework, the full-precision PEFT model may operate as the teacher model, and the quantization-constrained PEFT model may operate as the student model.

In an embodiment, the method 1200 may include selecting the quantization-sensitive PEFT model having the highest QSS among the plurality of QSSs associated with the plurality of PEFT models as the quantization-sensitive PEFT model.

In an embodiment, the method 1200 may include adjusting the one or more weights prior to execution of the plurality of PEFT models (e.g., prior to performing inference operations), and the adjusted one or more weights may be employable during runtime without further adjustment.

For example, the single quantized inference graph may be configured to support runtime switching among the plurality of PEFT models.

In an embodiment, the method 1200 may include executing the inference (e.g., performing inference operations or generating inference results) on at least one from among the edge device, the mobile NPU, the cloud accelerator, and the agent-based device.

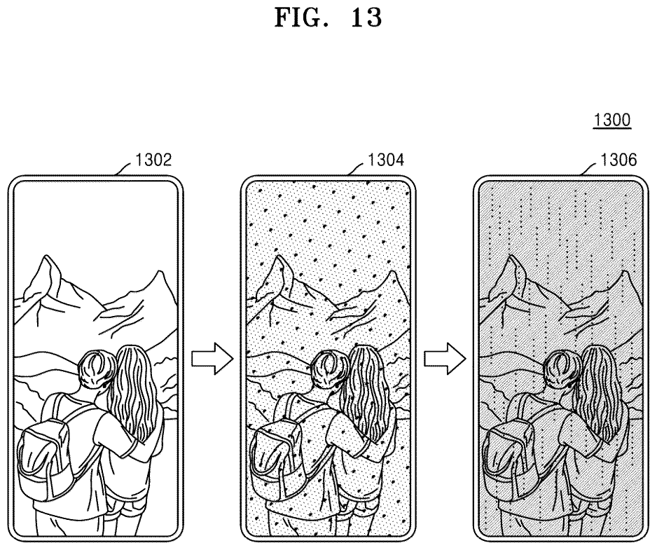

FIG. 13 illustrates an example use case for wallpaper generation, in accordance with an embodiment of the present disclosure.

As shown in FIG. 13, image 1302 represents a wallpaper generated under a sunny noon condition, image 1304 represents a wallpaper generated under a snowy sunset condition, and image 1306 represents a wallpaper generated under a rainy night condition. The images 1302, 1304, and 1306 demonstrate on-device deployment using the fixed quantization configuration, resulting in high image quality with no observable degradation in task accuracy.

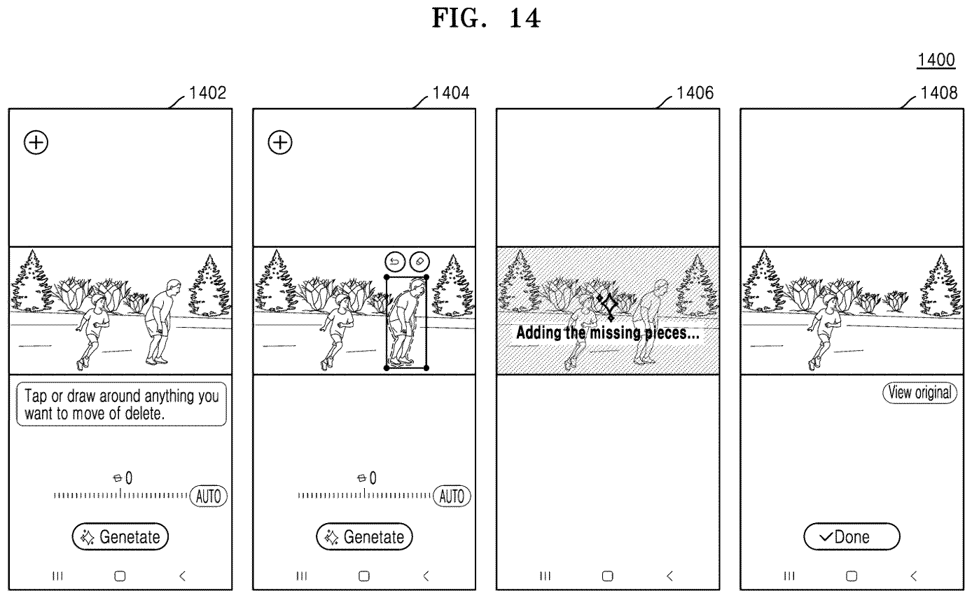

FIG. 14 illustrates an example use case for in-out painting, in accordance with an embodiment of the present disclosure.

As shown in FIG. 14, image 1402 includes two entities within a captured scene. The user may select one of the entities for removal, as indicated in image 1404. Upon applying the fixed quantization configuration, image 1406 shows an intermediate processing, and image 1408 presents the final output with the selected entity removed. The output maintains both visual fidelity and task accuracy, confirming the effectiveness of the quantization strategy.

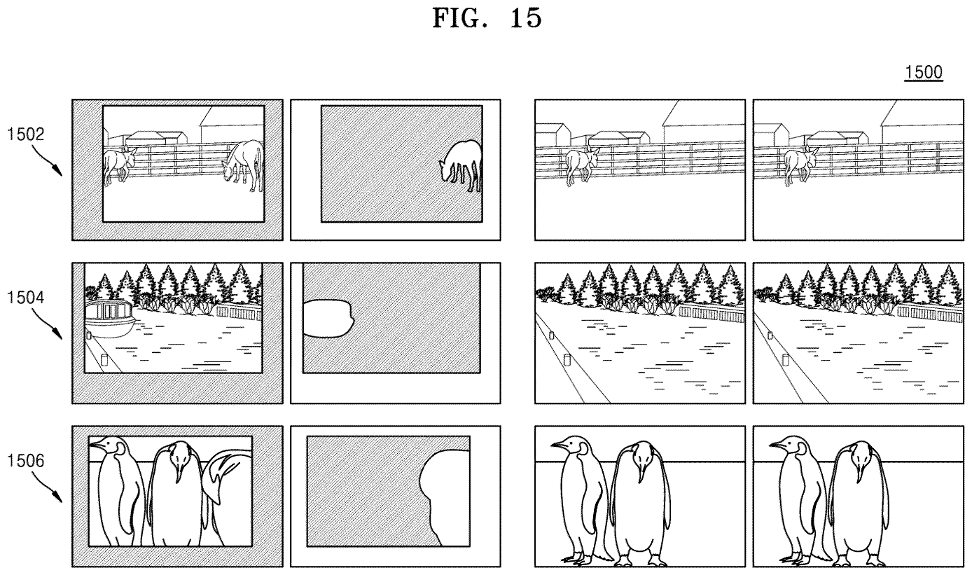

FIG. 15 illustrates a use case related to shared quantization parameters, in accordance with an embodiment of the present disclosure.

As shown in image 1502, image 1504, and image 1506, the quantization parameters originally determined for the wallpaper generation use case (as described in FIG. 13) are applied to the in-out painting use case. For example, an animal may be removed from the image 1502, a boat may be removed from the image 1504, and a penguin may be removed from the image 1506 using the same fixed quantization configuration. This demonstrates the generalizability and efficiency of the shared quantization approach across distinct generative tasks, according to embodiments.

Embodiments of the present disclosure may provide various advantages.

For example, embodiments may enable multiple PEFTs to share a single quantized inference graph, eliminating the need for per-task model duplication and significantly improving deployment scalability.

As another example, embodiments may introduce a pre-deployment harmonization step that aligns PEFT weight distributions using sensitivity-driven distillation, ensuring compatibility across tasks and improving inference stability.

As another example, embodiments may result in reduced memory usage, making the system and the method suitable for deployment in resource-constrained environments such as mobile devices, edge compute nodes, and embedded systems.

As another example, embodiments may eliminate or reduce redundant task-switching overhead, leading to faster task transitions and improved runtime efficiency.

As another example, embodiments may simplify the compilation process, enabling static graph execution and streamlining model preparation and deployment.

As another example, embodiments may enhance deployment efficiency across edge and cloud platforms, enabling consistent performance regardless of hardware constraints.

As another example, embodiments may be fully compatible with large language models (LLMs), large vision models (LVMs), multimodal models, and agentic systems, providing a unified and hardware-agnostic deployment framework.

As another example, embodiments may reduce deployment cost and time by removing the need for task-specific model engineering and quantization pipelines.

As another example, embodiments may enable plug-and-play monetization of AI features, allowing rapid integration of new capabilities using lightweight PEFT updates without full model retraining.

As another example, embodiments may support cross-device scalability, enabling a single deployment pipeline for mobile, extended reality (XR), automotive, and other platforms.

As would be apparent to a person having ordinary skill in the art, various working modifications may be made to the method in order to implement embodiments as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not necessarily limited to the manner described herein.

According to embodiments, the actions of any signal flow diagram need not be implemented in the order shown; nor do all of the acts necessarily need to be performed. Also, those acts that are not dependent on other acts may be performed in parallel with the other acts.

What is claimed is:

1. A method for generating a task-specific output using a single quantized model graph for a plurality of parameter efficient fine tuning (PEFT) models in a generative artificial intelligence (AI) system, the method comprising:
obtaining a base model that is pre-trained to perform a plurality of generative AI tasks corresponding to the plurality of PEFT models;
performing a quantization sensitivity analysis across the plurality of PEFT models to obtain a quantization sensitivity score (QSS) corresponding to each PEFT model from among the plurality of PEFT models;
selecting a quantization-sensitive PEFT model from among the plurality of PEFT models based on a corresponding QSS;
determining a fixed quantization configuration comprising a scale parameter and a zero-point parameter based on the selected quantization-sensitive PEFT model;
adjusting one or more weights associated with the plurality of PEFT models based on the fixed quantization configuration to obtain an adjusted plurality of PEFT models;
generating a single quantized model graph including the base model and the fixed quantization configuration, wherein the single quantized model graph allows dynamic selection from among the adjusted plurality of PEFT models; and
performing inference by selecting any one of the adjusted plurality of PEFT models and generating the task-specific output using the single quantized model graph.

2. The method as claimed in claim 1, further comprising:
performing preprocessing on each of the plurality of PEFT models before deployment to adjust the one or more weights.

3. The method as claimed in claim 1, wherein the one or more weights are adjusted using a knowledge distillation (KD) loss-based fine-tuning process.

4. The method as claimed in claim 1, wherein the one or more weights are adjusted using a knowledge distillation process, and
wherein the knowledge distillation process comprises minimizing a divergence metric between an output distribution generated by a PEFT model and an output distribution generated by a quantization-constrained version of the PEFT model.

5. The method as claimed in claim 1, wherein the one or more weights are adjusted by applying a task-specific loss to each PEFT model from among the plurality of PEFT models, and
wherein the task-specific loss comprises at least one from among a cross-entropy loss, a regression loss, and a classification loss.

6. The method as claimed in claim 1, wherein the one or more weights are adjusted using a teacher-student knowledge distillation framework including a full-precision PEFT model that operates as a teacher model and a quantization-constrained PEFT model that operates as a student model.

7. The method as claimed in claim 1, wherein a PEFT model having a highest QSS from among the plurality of PEFT models is selected as the quantization-sensitive PEFT model.

8. The method as claimed in claim 1, wherein the one or more weights are adjusted prior to execution of the plurality of PEFT models, and
wherein the adjusted one or more weights are used to perform the inference without further adjustment.

9. The method as claimed in claim 1, wherein the single quantized model graph is configured to support runtime switching among the plurality of PEFT models.

10. The method as claimed in claim 1, wherein the inference is performed by using at least one from among an edge device, a mobile neural processing unit (NPU), a cloud accelerator, and an agent-based device.

11. The method as claimed in claim 1, wherein the plurality of generative AI tasks comprises at least one from among a language generation task, a speech synthesis task, an image generation task, a visual recognition task, a segmentation task, and a multimodal reasoning task.

12. An electronic device for generating a task-specific output using a single quantized model graph for a plurality of parameter efficient fine tuning (PEFT) models using generative artificial intelligence (AI), the electronic device comprising:
at least one processor; and
a memory storing instructions which, when executed by the at least one processor, cause the electronic device to:
obtain a base model that is pre-trained to perform a plurality of generative AI tasks corresponding to the plurality of PEFT models;
perform a quantization sensitivity analysis across the plurality of PEFT models to obtain a quantization sensitivity score (QSS) corresponding to each PEFT model from among the plurality of PEFT models;
select a quantization-sensitive PEFT model from among the plurality of PEFT models based on a corresponding QSS;
determine a fixed quantization configuration comprising a scale parameter and a zero-point parameter based on the selected quantization-sensitive PEFT model;
adjust one or more weights associated with the plurality of PEFT models based on the fixed quantization configuration to obtain an adjusted plurality of PEFT models;
generate a single quantized model graph including the base model and the fixed quantization configuration, wherein the single quantized model graph allows dynamic selection from among the adjusted plurality of PEFT models; and
perform inference by selecting any one of the adjusted plurality of PEFT models and generating the task-specific output using the single quantized model graph.

13. The electronic device as claimed in claim 12, wherein the instructions, when executed by the at least one processor, further cause the electronic device to perform preprocessing on each PEFT model from among the plurality of PEFT models before deployment to adjust the one or more weights.

14. The electronic device as claimed in claim 12, wherein the instructions, when executed by the at least one processor, further cause the electronic device to adjust the one or more weights using a knowledge distillation (KD) loss-based fine-tuning process.

15. The electronic device as claimed in claim 12, wherein the instructions, when executed by the at least one processor, further cause the electronic device to adjust the one or more weights using a knowledge distillation process, and
wherein the knowledge distillation process comprises minimizing a divergence metric between an output distribution generated by a PEFT model and an output distribution generated by a quantization-constrained version of the PEFT model.

16. The electronic device as claimed in claim 12, wherein the instructions, when executed by the at least one processor, further cause the electronic device to adjust the one or more weights by applying a task-specific loss to each PEFT model from among the plurality of PEFT models, and
wherein the task-specific loss comprises at least one from among a cross-entropy loss, a regression loss, and a classification loss.

17. The electronic device as claimed in claim 12, wherein the instructions, when executed by the at least one processor, further cause the electronic device to adjust the one or more weights using a teacher-student knowledge distillation framework including a full-precision PEFT model that operates as a teacher model and a quantization-constrained PEFT model that operates as a student model.

18. The electronic device as claimed in claim 12, wherein the instructions, when executed by the at least one processor, further cause the electronic device to select a PEFT model associated with a highest QSS from among the plurality of PEFT models as the quantization-sensitive PEFT model.

19. The electronic device as claimed in claim 12, wherein the instructions, when executed by the at least one processor, further cause the electronic device to adjust the one or more weights prior to execution of the plurality of PEFT models, and
wherein the adjusted one or more weights are used to perform the inference without further adjustment.

20. The electronic device as claimed in claim 12, wherein the single quantized model graph is configured to support runtime switching among the plurality of PEFT models.
